(19) United States
(12) Patent Application Publication
(10) Pub. No.: US 2003/0235016 A1
(43) Pub. Date: Dec. 25, 2003

(54) Stabilization structures for CPP sensor

(75) Inventor: Hardayal Singh Gill, Palo Alto, CA (US)

Correspondence Address: William D. Gill, IBM Corporation, Intellectual Property Law, 5600 Cottle Road ( L2PA/0142), San Jose, CA, 95193, US

(73) Assignee: International Business Machines Corporation, Armonk, NY

(21) Appl. No.: 10/175,679

(22) Filed: Jun. 19, 2002

(51) Int. Cl. G11B 5/39

(52) U.S. Cl. 360/324.12; 360/324.2

(57) ABSTRACT

Current-perpendicular-to-plane (CPP) spin valve (SV) and magnetic tunnel junction (MTJ) sensors are provided having an antiparallel (AP)-coupled longitudinal bias stack for instack biasing to stabilize the free layer. A CPP sensor comprises a longitudinal bias stack adjacent to and in contact with a free (sense) layer of the sensor. The bias stack comprises an antiparallel (AP)-pinned layer including FM1 and FM2 layers separated by an antiparallel coupling (APC) layer. The FM1 layer is separated from the free layer of the sensor by a nonmagnetic spacer layer. By choosing the relative thicknesses of the FM1 and FM2 layers, the bias field H_{B} from the AP-pinned layer and the ferromagnetic coupling field H_{FC} between the FM1 layer and the free layer is made additive at the free layer for either positive or negative coupling. By ensuring that the bias field adds to the coupling field, the stability of the free layer by in-stack longitudinal biasing is improved.

### BACKGROUND OF THE INVENTION

1. Field of the Invention

This invention relates in general to magnetic transducers for reading information signals from a magnetic medium and, in particular, to a current perpendicular to the plane sensor with an improved stabilization structure which allows addition of ferromagnetic coupling and magnetostatic bias at the free layer.

2. Description of the Related Art

Computers often include auxiliary memory storage devices having media on which data can be written and from which data can be read for later use. A direct access storage device (disk drive) incorporating rotating magnetic disks is commonly used for storing data in magnetic form on the disk surfaces. Data is recorded on concentric, radially spaced tracks on the disk surfaces. Magnetic heads including read sensors are then used to read data from the tracks on the disk surfaces.

In high capacity disk drives, magnetoresistive (MR) read sensors, commonly referred to as MR sensors, are the prevailing read sensors because of their capability to read data from a surface of a disk at greater track and linear densities than thin film inductive heads. An MR sensor detects a magnetic field through the change in the resistance of its MR sensing layer (also referred to as an “MR element”) as a function of the strength and direction of the magnetic flux being sensed by the MR layer.

The conventional MR sensor operates on the basis of the anisotropic magnetoresistive (AMR) effect in which an MR element resistance varies as the square of the cosine of the angle between the magnetization in the MR element and the direction of sense current flowing through the MR element. Recorded data can be read from a magnetic medium because the external magnetic field from the recorded magnetic medium (the signal field) causes a change in the direction of magnetization in the MR element, which in turn causes a change in resistance in the MR element and a corresponding change in the sensed current or voltage.

Another type of MR sensor is the giant magnetoresistance (GMR) sensor manifesting the GMR effect. In GMR sensors, the resistance of the MR sensing layer varies as a function of the spin-dependent transmission of the conduction electrons between magnetic layers separated by a non-magnetic layer (spacer) and the accompanying spin-dependent scattering which takes place at the interface of the magnetic and non-magnetic layers and within the magnetic layers.

GMR sensors using only two layers of ferromagnetic material (e.g., Ni—Fe) separated by a layer of non-magnetic material (e.g., copper) are generally referred to as spin valve (SV) sensors manifesting the SV effect.

FIG. 1 shows a prior art SV sensor 100 comprising end regions 104 and 106 separated by a central region 102. A first ferromagnetic layer, referred to as a pinned layer 120, has its magnetization typically fixed (pinned) by exchange coupling with an antiferromagnetic (AFM) layer 125. The magnetization of a second ferromagnetic layer, referred to as a free layer 110, is not fixed and is free to rotate in response to the magnetic field from the recorded magnetic medium (the signal field). The free layer 110 is separated from the pinned layer 120 by a non-magnetic, electrically conducting spacer layer 115. Hard bias layers 130 and 135 formed in the end regions 104 and 106, respectively, provide longitudinal bias for the free layer 110. Leads 140 and 145 formed on hard bias layers 130 and 135, respectively, provide electrical connections for sensing the resistance of SV sensor 100. In the SV sensor 100, because the sense current flow between the leads 140 and 145 is in the plane of the SV sensor layers, the sensor is known as a current-in-plane (CIP) SV sensor. IBM's U.S. Pat. No. 5,206,590 granted to Dieny et al., incorporated herein by reference, discloses a GMR sensor operating on the basis of the SV effect.

Another type of spin valve sensor is an antiparallel pinned (AP) spin valve sensor. The AP-pinned spin valve sensor differs from the simple simple spin valve sensor in that an AP-pinned structure has multiple thin film layers instead of a single pinned layer. The AP-pinned structure has an antiparallel coupling (APC) layer sandwiched between first and second ferromagnetic pinned layers. The first pinned layer has its magnetization oriented in a first direction by exchange coupling to the antiferromagnetic pinning layer. The second pinned layer is immediately adjacent to the free layer and is antiparallel exchange coupled with the first pinned layer because of the selected thickness (in the order of 8 Å) of the APC layer between the first and second pinned layers. Accordingly, the magnetization of the second pinned layer is oriented in a second direction that is antiparallel to the direction of the magnetization of the first pinned layer.

The AP-pinned structure is preferred over the single pinned layer because the magnetizations of the first and second pinned layers of the AP-pinned structure subtractively combine to provide a net magnetization that is less than the magnetization of the single pinned layer. The direction of the net magnetization is determined by the thicker of the first and second pinned layers. A reduced net magnetization equates to a reduced demagnetization field from the AP-pinned structure. Since the antiferromagnetic exchange coupling is inversely proportional to the net pinning magnetization, this increases exchange coupling between the first pinned layer and the antiferromagnetic pinning layer. The AP-pinned spin valve sensor is described in commonly assigned U.S. Pat. No. 5,465,185 to Heim and Parkin which is incorporated by reference herein.

Another type of magnetic device currently under development is a magnetic tunnel junction (MTJ) device. The MTJ device has potential applications as a memory cell and as a magnetic field sensor. The MTJ device comprises two ferromagnetic layers separated by a thin, electrically insulating, tunnel barrier layer. The tunnel barrier layer is sufficiently thin that quantum-mechanical tunneling of charge carriers occurs between the ferromagnetic layers. The tunneling process is electron spin dependent, which means that the tunneling current across the junction depends on the spin-dependent electronic properties of the ferromagnetic materials and is a function of the relative orientation of the magnetic moments, or magnetization directions, of the two ferromagnetic layers. In the MTJ sensor, one ferromagnetic layer has its magnetic moment fixed, or pinned, and the other ferromagnetic layer has its magnetic moment free to rotate in response to an external magnetic field from the recording medium (the signal field). When an electric potential is applied between the two ferromagnetic layers, the sensor resistance is a function of the tunneling current across the insulating layer between the ferromagnetic layers. Since the tunneling current that flows perpendicularly through the tunnel barrier layer depends on the relative magnetization directions of the two ferromagnetic layers, recorded data can be read from a magnetic medium because the signal field causes a change of direction of magnetization of the free layer, which in turn causes a change in resistance of the MTJ sensor and a corresponding change in the sensed current or voltage. Because the sensing current is perpendicular to the plane of the sensor layers, the MTJ sensor is known as a current-perpendicular-to-plane (CPP) sensor. IBM's U.S. Pat. No. 5,650,958 granted to Gallagher et al a MTJ sensor operating on the basis of the magnetic tunnel junction effect.

Two types of current-perpendicular-to-plane (CPP) sensors have been extensively explored for magnetic recording at ultrahigh densities (≦20 Gb/in²). One is a GMR spin valve sensor and the other is a MTJ sensor. When the CPP sensor is used, magnetic stabilization of the free (sense) layer can be difficult due to the use of insulating layers to avoid current shorting around the active region of the sensor. Therefore, theres is a continuing need to improve the magnetic stabilization of CPP type magnetoresistive sensors to improve sensor stability.

### SUMMARY OF THE INVENTION

It is an object of the present invention to disclose current-perpendicular-to-plane (CPP) spin valve (SV) and magnetic tunnel junction (MTJ) sensors having an antiparallel (AP)-pinned longitudinal bias stack for instack biasing to stabilize the free layer.

It is another object of the present invention to disclose CPP SV and MTJ sensors having an AP-pinned longitudinal bias stack in which the bias field from the bias layer stack adds to the coupling field between the free layer and the bias stack.

It is a further object of the present invention to disclose CPP SV and MTJ sensors having a longitudinal bias stack adjacent to the free layer comprising a spacer layer, a first ferromagnetic (FM1) layer, an antiparallel coupling (APC) layer, a second ferromagnetic (FM2) layer and an antiferromagnetic (AFM) layer.

It is yet another object of the present invention to disclose CPP SV and MTJ sensors having a longitudinal bias stack adjacent to the free layer in which the FM1 layer is made thicker than the FM2 layer if the ferromagnetic coupling between the free layer and the FM1 layer is negative (antiparallel).

It is still another object of the present invention to disclose CPP SV and MTJ sensors having a longitudinal bias stack adjacent to the free layer in which the FM2 layer is made thicker than the FM1 layer if the ferromagnetic coupling between the free layer and the FM1 layer is positive (parallel).

In accordance with the principles of the present invention, there is disclosed a first embodiment of the present invention wherein a CPP SV sensor comprises a SV stack and a longitudinal bias stack adjacent to and in contact with a free (sense) layer of the SV stack. The bias stack comprises an antiparallel (AP)-pinned layer including FM1 and FM2 layers separated by an APC layer. The FM1 layer is separated from the free layer of the SV stack by a nonmagnetic spacer layer. Depending on material and thickness of the spacer layer, ferromagnetic coupling between the FM1 layer and the free layer may be either positive or negative. By choosing the relative magnetic thicknesses of the FM1 layer and the FM2 layer, the bias field H_{B} from the AP-pinned layer and the ferromagnetic coupling field H_{FC} across the spacer layer can be made additive at the free layer for either positive or negative coupling. If the coupling across the spacer layer is positive (ferromagnetic), the thickness of the FM2 layer is chosen to be greater than the thickness of the FM1 layer. If the coupling across the spacer layer is negative (antiferromagnetic), the thickness of the FM1 layer is chosen to be greater than the thickness of the FM2 layer. By ensuring that the bias field adds to the coupling field, the stability of the free layer by in-stack biasing is improved.

In accordance with the principles of the present invention, there is disclosed a second embodiment of the present invention wherein a CPP MTJ sensor comprises an MTJ stack and a longitudinal bias stack adjacent to and in contact with a free (sense) layer of the MTJ stack. The bias stack comprises an antiparallel (AP)-pinned layer including FM1 and FM2 layers separated by an APC layer. The FM1 layer is separated from the free layer of the SV stack by a nonmagnetic spacer layer. Depending on material and thickness of the spacer layer, ferromagnetic coupling between the FM1 layer and the free layer may be either positive or negative. By choosing the relative magnetic thicknesses of the FM1 layer and the FM2 layer, the bias field H_{B} from the AP-pinned layer and the ferromagnetic coupling field H_{FC} across the spacer layer can be made additive at the free layer for either positive or negative coupling. If the coupling across the spacer layer is positive (ferromagnetic), the thickness of the FM2 layer is chosen to be greater than the thickness of the FM1 layer. If the coupling across the spacer layer is negative (antiferromagnetic), the thickness of the FM1 layer is chosen to be greater than the thickness of the FM2 layer. By ensuring that the bias field adds to the coupling field, the stability of the free layer by in-stack longitudinal biasing is improved.

### BRIEF DESCRIPTION OF THE DRAWINGS

For a fuller understanding of the nature and advantages of the present invention, as well as the preferred mode of use, reference should be made to the following detailed description read in conjunction with the accompanying drawings. In the following drawings, like reference numerals designate like or similar parts throughout the drawings.

FIG. 1 is an air bearing surface view, not to scale, of a prior art SV sensor;

FIG. 2 is a simplified diagram of a magnetic recording disk drive system using the MTJ sensor of the present invention;

FIG. 3 is a vertical cross-section view, not to scale, of a “piggyback” read/write magnetic head;

FIG. 4 is a vertical cross-section view, not to scale, of a “V merged” read/write magnetic head;

FIG. 5 is an air bearing surface view, not to scale, of a CPP spin valve embodiment of the present invention; and

FIG. 6 is an air bearing surface view, not to scale, of a CPP magnetic tunnel junction embodiment of the present invention.

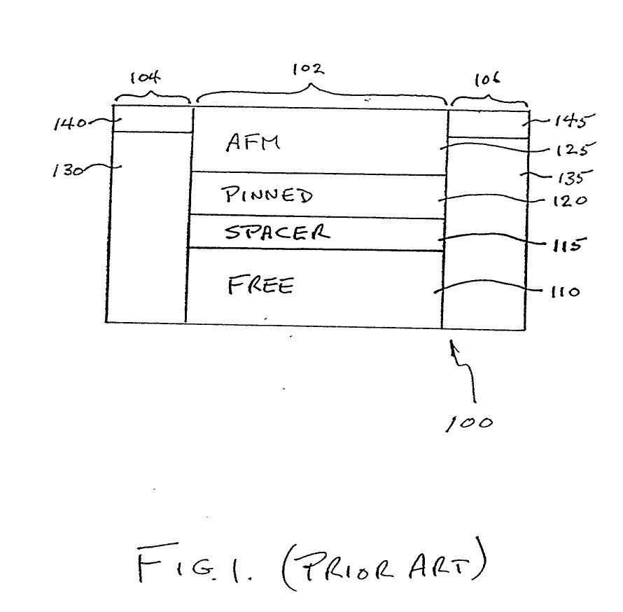

### DETAILED DESCRIPTION OF THE PREFERRED EMBODIMENT

The following description is the best embodiment presently contemplated for carrying out the present invention. This description is made for the purpose of illustrating the general principles of the present invention and is not meant to limit the inventive concepts claimed herein.

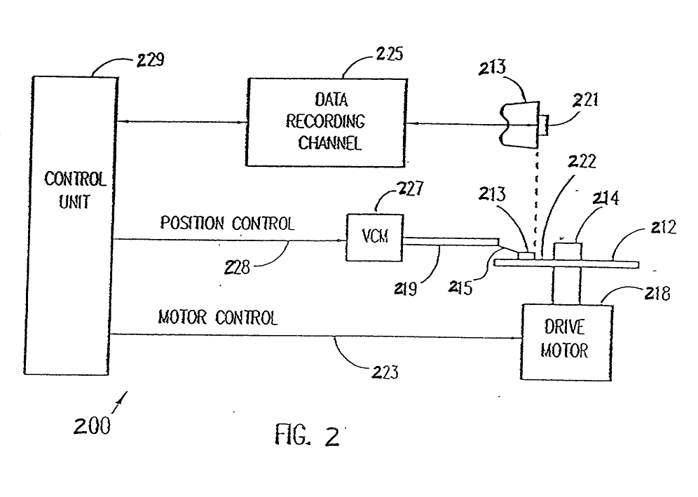

Referring now to FIG. 2, there is shown a disk drive 200 embodying the present invention. As shown in FIG. 2, at least one rotatable magnetic disk 212 is supported on a spindle 214 and rotated by a disk drive motor 218. The magnetic recording media on each disk is in the form of a coating on the surfaces of the disk 212 on which the data is recorded as an annular pattern of concentric data tracks (not shown).

At least one slider 213 is positioned on the disk 212, each slider 213 supporting one or more magnetic read/write heads 221 where the head 221 incorporates the SV sensor of the present invention. As the disks rotate, the slider 213 is moved radially in and out over the disk surface 222 so that the heads 221 may access different portions of the disk where desired data is recorded. Each slider 213 is attached to an actuator arm 219 by means of a suspension 215. The suspension 215 provides a slight spring force which biases the slider 213 against the disk surface 222. Each actuator arm 219 is attached to an actuator 227. The actuator as shown in FIG. 2 may be a voice coil motor (VCM). The VCM comprises a coil that is movable within a fixed magnetic field, the direction and speed of the coil movements being controlled by the motor current signals supplied by a controller 229.

During operation of the disk storage system, the rotation of the disk 212 generates an air bearing between the slider 213 (the surface of the slider 213 which includes the head 321 and faces the surface of the disk 212 is referred to as an air bearing surface (ABS)) and the disk surface 222 which exerts an upward force or lift on the slider. The air bearing thus counter-balances the slight spring force of the suspension 215 and supports the slider 213 off and slightly above the disk surface by a small, substantially constant spacing during normal operation.

The various components of the disk storage system are controlled in operation by control signals generated by the control unit 229, such as access control signals and internal clock signals. Typically, the control unit 229 comprises logic control circuits, storage chips and a microprocessor. The control unit 229 generates control signals to control various system operations such as drive motor control signals on line 223 and head position and seek control signals on line 228. The control signals on line 228 provide the desired current profiles to optimally move and position the slider 213 to the desired data track on the disk 212. Read and write signals are communicated to and from the read/write heads 221 by means of the recording channel 225. Recording channel 225 may be a partial response maximum likelihood (PMRL) channel or a peak detect channel. The design and implementation of both channels are well known in the art and to persons skilled in the art. In the preferred embodiment, recording channel 225 is a PMRL channel.

The above description of a typical magnetic disk storage system, and the accompanying illustration of FIG. 2 are for representation purposes only. It should be apparent that disk storage systems may contain a large number of disks and actuator arms, and each actuator arm may support a number of sliders.

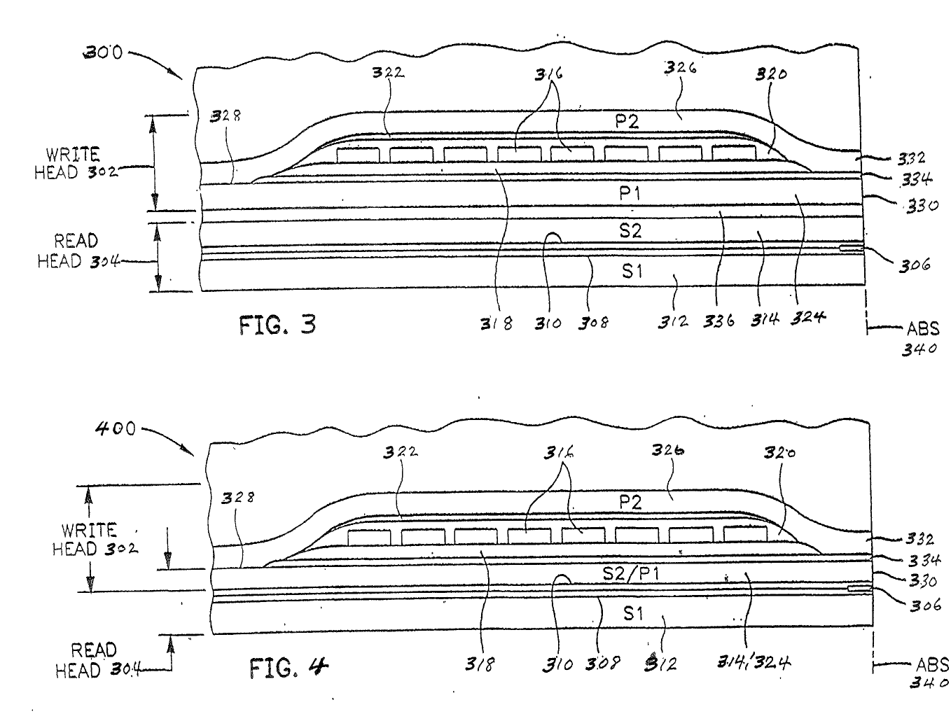

FIG. 3 is a side cross-sectional elevation view of a “piggyback” magnetic read/write head 300, which includes a write head portion 302 and a read head portion 304, the read head portion employing a CPP magnetoresistive sensor 306 according to the present invention. The sensor 306 is sandwiched between nonmagnetic insulative first and second read gap layers 308 and 310, and the read gap layers are sandwiched between ferromagnetic first and second shield layers 312 and 314. In response to external magnetic fields, the resistance of the sensor 306 changes. A sense current Iₛ conducted through the sensor causes these resistance changes to be manifested as potential changes. These potential changes are then processed as readback signals by the processing circuitry of the data recording channel 246 shown in FIG. 2.

The write head portion 302 of the magnetic read/write head 300 includes a coil layer 316 sandwiched between first and second insulation layers 318 and 320. A third insulation layer 322 may be employed for planarizing the head to eliminate ripples in the second insulation layer 320 caused by the coil layer 316. The first, second and third insulation layers are referred to in the art as an insulation stack. The coil layer 316 and the first, second and third insulation layers 38, 320 and 322 are sandwiched between first and second pole piece layers 324 and 326. The first and second pole piece layers 324 and 326 are magnetically coupled at a back gap 328 and have first and second pole tips 330 and 332 which are separated by a write gap layer 334 at the ABS 340. An insulation layer 336 is located between the second shield layer 314 and the first pole piece layer 324. Since the second shield layer 314 and the first pole piece layer 324 are separate layers this read/write head is known as a “piggyback” head.

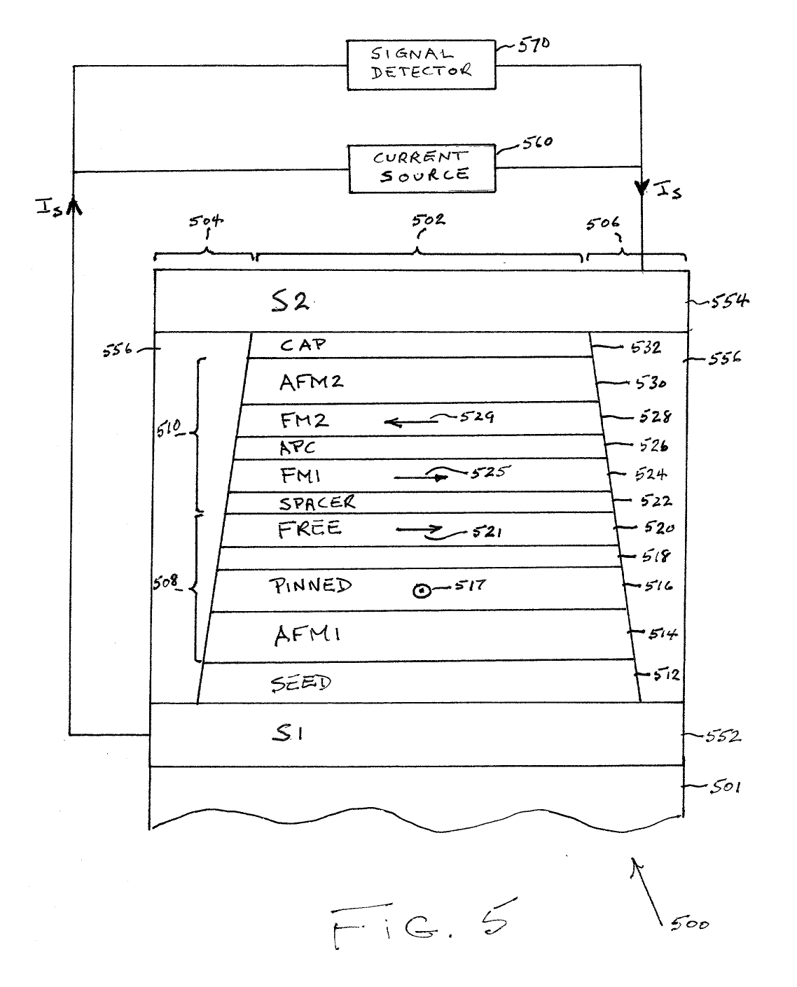

FIG. 4 is the same as FIG. 3 except the second shield layer 414 and the first pole piece layer 424 are a common layer. This type of read/write head is known as a “merged” head 400. The insulation layer 336 of the piggyback head in FIG. 3 is omitted in the merged head 400 of FIG. 4.

### FIRST EXAMPLE

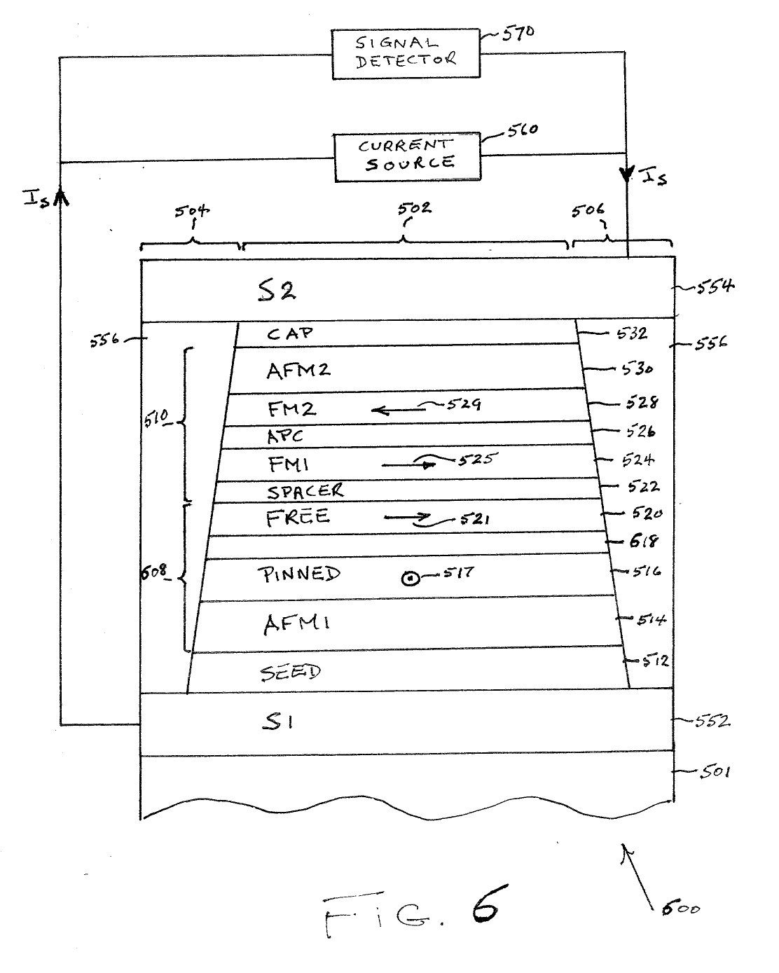

FIG. 5 shows an air bearing surface (ABS) view, not to scale, of a CPP spin valve (SV) sensor 500 according to a first embodiment of the present invention. The SV sensor 500 comprises end regions 504 and 506 separated from each other by a central region 502. The active region of the SV sensor comprises a CPP spin valve (SV) stack 508 and a longitudinal bias stack 510 formed in the central region 502. The seed layer 512 is a layer deposited to modify the crystallographic texture or grain size of the subsequent layers, and may not be needed depending on the subsequent layer. The SV stack 508 sequentially deposited over the seed layer 512 comprises a first antiferromagnetic (AFM1) layer 514, a ferromagnetic pinned layer 516, a conductive spacer layer 518 and a ferromagnetic free (sense) layer 520. The AFM1 layer 514 has a thickness, typically 50-500 Å, at which the desired exchange properties are achieved with the pinned layer 516.

The longitudinal bias stack 510 sequentially deposited over the SV stack 508 comprises a nonmagnetic spacer layer 522, a first ferromagnetic (FM1) layer 524, an antiparallel coupling (APC) layer 526, a second ferromagnetic (FM2) layer 528, and a second antiferromagnetic (AFM) layer 530. The APC layer 526 is formed of a nonmagnetic material, preferably ruthenium (Ru), that allows the FM1 and FM2 layers 524 and 528 to be strongly coupled together antiferromagnetically forming an AP-pinned layer structure whose magnetization is pinned by the second AFM layer 530. The AFM2 layer 530 has a thickness, typically 50-500 Å, at which the desired exchange properties are achieved with the FM2 layer 528. A cap layer 532, formed on the AFM2 layer 530, completes the central region 502 of the SV sensor 500.

The AFM1 layer 514 is exchange coupled to the pinned layer 516 to provide a pinning magnetic field to pin the magnetization of the pinned layer perpendicular to the ABS as indicated by the arrow head 517 pointing out of the plane of the paper. The free layer 520 has a magnetization 521 that is free to rotate in the presence of an external (signal) magnetic field. The magnetization 521 of the free layer 520 is preferably oriented parallel to the ABS in the absence of an external magnetic field, and may, alternatively, have an orientation opposite in direction to the magnetization 521.

The AFM2 layer 530 is exchange coupled to the AP-pinned layer comprising the FM1 and FM2 layers 524 and 528 to provide a pinning magnetic field to pin the magnetizations of the two ferromagnetic layers parallel to the ABS as indicated by the arrows 525 and 529, respectively. The net magnetization of the AP-pinned layer provides a longitudinal bias field which forms a flux closure with the free layer 520 to provide longitudinal stabilization of the magnetic domain states of the free layer.

First and second shield layers 552 and 554 adjacent to the seed layer 512 and the cap layer 632 provide electrical connections for the flow of a sensing current Is from a current source 560 to the SV sensor 500. A signal detector 570 which is electrically connected to first and second shields 552 and 554 senses the change in resistance due to changes induced in the sense layer 520 by the external magnetic field (e.g., field generated by a data bit stored on a disk). The external field acts to rotate the direction of magnetization of the sense layer 520 relative to the direction of magnetization of the pinned layer 516 which is preferably pinned perpendicular to the ABS. The signal detector 570 preferably comprises a partial response maximum likelihood (PRML) recording channel for processing the signal detected by MTJ sensor 500. Alternatively, a peak detect channel or a maximum likelihood channel (e.g., 1.7 ML) may be used. The design and implementation of the aforementioned channels are known to those skilled in the art. The signal detector 570 also includes other supporting circuitries such as a preamplifier (electrically placed between the sensor and the channel) for conditioning the sensed resistance changes as is known to those skilled in the art.

The SV sensor 500 is fabricated in a magnetron sputtering or an ion beam sputtering system to sequentially deposit the multilayer structure shown in FIG. 5. The sputter deposition process is carried out in the presence of a longitudinal or transverse magnetic field of about 40 Oe to orient the easy axis of all the ferromagnetic layers. The first shield layer 552 formed of Ni—Fe having a thickness in the range of 5000-10000 Å is deposited on a substrate 501. The seed layer 512 formed of a nonmagnetic metal, preferably tantalum (Ta), having a thickness of about 30 Å is deposited on the first shield 512. The SV stack 508 is formed on the seed layer by sequentially depositing the AFM1 layer 514 of Pt—Mn having a thickness of 100-200 Å, the pinned layer 516 of Ni—Fe, or alternatively of Co—Fe, having a thickness in the range of 20-50 Å, the conductive spacer layer 518 formed of copper having a thickness of about 20 Å, and the free layer 520 formed of Ni—Fe, or alternatively of Co—Fe, having a thickness in the range of 10-40 Å.

The longitudinal bias stack 510 is formed on the SV stack 508 by sequentially depositing the spacer layer 522 formed of copper (Cu), or of alternatively ruthenium (Ru), rhodium (Rh), tantalum (Ta) or some combination of these materials, having a thickness in the range of 5-30 Å, the FM1 layer 524 formed of Co—Fe, or alternatively of Co, Ni—Fe or Co—Fe—Ni, having a thickness in the range of 10-30 Å, the APC layer 526 formed of ruthenium (Ru) having a thickness of about 8 Å, the FM2 layer 528 formed of Co—Fe, or alternatively of Co, Ni—Fe or Co—Fe—Ni, having a thickness in the range of 10-30 Å, and the AFM2 layer 530 formed of PtMn having a thickness in the range of 100-200 Å. Alternatively, the AFM2 layer may be formed of an antiferromagnetic material having a blocking temperature different from the material of the AFM1 layer. The cap layer 532 formed of tantalum (Ta) having a thickness of about 50 Å is deposited on the AFM2 layer 530.

The second shield layer 554 formed of Ni—Fe having a thickness in the range of 5000-10000 Å is deposited over the cap layer 532. An insulating layer 556 formed of Al₂O₃ deposited between the first shield layer 552 and the second shield layer 554 in the end regions 504 and 506 provides electrical insulation between the shields/leads and prevents shunting of the sense current around the active region 502 of the sensor.

After the deposition of the central portion 502 is completed, the AFM1 layer 514 is set transverse to the ABS and the AFM2 layer 530 is set longitudinal to the ABS using procedures well known to the art.

According to the invention, the longitudinal bias field H_{B} at the free layer provided by the longitudinal bias stack 510 is always additive with the ferromagnetic coupling field H_{FC} between the FM1 layer 524 and the free layer 520. With prior art in-stack longitudinal bias structures using a simple pinned layer, addition of H_{B} and H_{FC} can only be achieved for the case of negative ferromagnetic coupling across the spacer layer disposed between the longitudinal bias layer stack and the free layer. Since the sign and strength of coupling across a spacer layer is strongly dependent on both thickness and material, this restriction can be a problem for achieving a good in-stack bias design. With the AP-pinned layer structure in the bias stack 510 of the present invention, additive fields H_{B} and H_{FC} can be achieved for both positive (ferromagnetic) and negative (antiferromagnetic) coupling across the spacer layer 522 by proper choice of the relative magnetic thicknesses of the FM1 and FM2 layers 524 and 528.

For the embodiment shown in FIG. 5, positive coupling between the bias (FM1) layer and the free layer has been assumed. For positive coupling, H_{FC} at the free layer is a field having the same direction as the magnetization of the FM1 layer as indicated by the arrow 525. In order for closure of the instack bias field H_{B} from the bias strack 510 to have the same direction as H_{FC} at the free layer, the net magnetization of the AP-pinned layer must have the same direction as the magnetization of the FM2 layer 528 as indicated by the arrow 529. This requirement is met by choosing the thickness of the FM2 layer 528 to be greater than the thickness of the FM1 layer 524 (FM2>FM1). With this choice of the relative thicknesses of FM1 and FM2, the bias field H_{B} and the ferromagnetic coupling field H_{FC} are additive at the free layer and have the direction indicated by the magnetization 521 of the free layer.

Alternatively, if the coupling between the bias (FM1) layer and the free layer is negative (antiparallel), H_{FC} at the free layer is a field having the opposite direction to the magnetization of the FM1 layer as indicated by the arrow 525. In order for closure of the instack bias field H_{B} from the bias stack 510 to have the same direction as H_{FC} at the free layer, the net magnetization of the AP-pinned layer must have the same direction as the magnetization of the FM1 layer 524 as indicated by the arrow 525. This requirement is met by choosing the thickness of the FM1 layer 524 to be greater than the thickness of the FM2 layer 528 (FM1>FM2). With this choice of the relative thicknesses of FM1 and FM2, the bias field H_{B} and the ferromagnetic coupling field H_{FC} are additive at the free layer and have the opposite direction to that indicated by the arrow 521 in FIG. 5.

### SECOND EXAMPLE

FIG. 6 shows an air bearing surface (ABS) view, not to scale, of a CPP magnetic tunnel junction (MTJ) sensor 600 according to a second embodiment of the present invention. The MTJ sensor 600 differs from the SV sensor 500 in having an MTJ stack 608 in place of the SV stack 508. The active region of the MTJ sensor comprises the MTJ stack 608 and the longitudinal bias stack 510 formed in the central region 502. The MTJ stack 608 sequentially deposited over the seed layer 512 comprises a first antiferromagnetic (AFM1) layer 514, a ferromagnetic pinned layer 516, an insulating tunnel barrier layer 618 and a ferromagnetic free (sense) layer 520. The insulating tunnel barrier layer 618, preferably formed of Al₂O₃, replaces the conductive spacer layer 518 of the CPP SV sensor 500 of the first example.

The longitudinal bias stack 510 sequentially deposited over the MTJ stack 608 has the same structure as the bias stack of the first example including a spacer layer 522, an AP-pinned layer comprising FM1 and FM2 layers 524 and 528, respectively, separated by an APC layer 526 and an AFM2 layer 530. The net magnetization of the AP-pinned layer provides a longitudinal bias field which forms a flux closure with the free layer 520 to provide longitudinal stabilization of the magnetic domain states of the free layer 521 of the MTJ stack 608.

The MTJ sensor 600 is fabricated in a magnetron sputtering or an ion beam sputtering system to sequentially deposit the multilayer structure shown in FIG. 6. The sputter deposition process is the same as that used to fabricate the CPP SV sensor 500 except for deposition of the tunnel barrier layer 618 in place of the conductive spacer layer 518. The tunnel barrier layer 618 of Al₂O₃ is deposited on the pinned layer 516 by depositing and then plasma oxidizing an 8-20 Å aluminum (Al) layer. The free layer 520 is then deposited on the tunnel barrier layer 618.

The process of choosing the relative thicknesses of the FM1 layer 524 and the FM2 layer 528 so that the bias field H_{B} and the ferromagnetic coupling field H_{FC} are additive at the free layer 520 for either positive or negative coupling of spacer layer 522 is the same as discussed above with respect to the first example. If the coupling across the spacer layer 522 is positive (ferromagnetic), the thickness of the FM2 layer 528 is chosen to be greater than the thickness of the FM1 layer 524. If the coupling across the spacer layer 522 is negative (antiferromagnetic), the thickness of the FM1 layer 524 is chosen to be greater than the thickness of the FM2 layer 528.

While the present invention has been particularly shown and described with reference to the preferred embodiments, it will be understood to those skilled in the art that various changes in form and detail may be made without departing from the spirit, scope and teaching of the invention. Accordingly, the disclosed invention is to be considered merely as illustrative and limited only as specified in the appended claims.

I claim:

1. A spin valve (SV) magnetoresistive sensor, comprising:
a spin valve (SV) stack comprising:
a first antiferromagnetic (AFM1) layer;
a ferromagnetic pinned layer adjacent to said AFM1 layer;
a ferromagnetic free layer; and
a spacer layer disposed between said pinned layer and said free layer;
a bias stack for applying a longitudinal bias field to said free layer, said bias stack comprising:
a second antiferromagnetic (AFM2) layer;
a first ferromagnetic (FM1) layer;
a second ferromagnetic (FM2) layer adjacent to said AFM2 layer;
an antiparallel coupling layer disposed between said FM1 and FM2 layers; and
a nonmagnetic spacer layer disposed between said FM1 layer and said free layer.

2. The spin valve (SV) magnetoresistive sensor recited in claim 1, wherein said FM2 layer has a thickness greater than the thickness of said FM1 layer and said FM1 layer has a positive (parallel) ferromagnetic coupling with said free layer.

3. The spin valve (SV) magnetoresistive sensor recited in claim 1, wherein said FM1 layer has a thickness greater than the thickness of said FM2 layer and said FM1 layer has a negative (antiparallel) ferromagnetic coupling with said free layer.

4. The spin valve (SV) magnetoresistive sensor recited in claim 1, wherein said spacer layer of the bias stack is selected from the group of materials consisting of copper (Cu), ruthenium (Ru), rhodium (Rh) and tantalum (Ta).

5. The spin valve (SV) magnetoresistive sensor recited in claim 1, wherein said spacer layer of the bias stack has a thickness in the range of 5-30 Å.

6. The spin valve (SV) magnetoresistive sensor recited in claim 1, wherein said FM1 and FM2 layers of the bias stack are selected from the group of materials consisting of Co—Fe, Co, Ni—Fe and Co—Fe—Ni.

7. A magnetic tunnel junction (MTJ) magnetoresistive sensor, comprising:
a magnetic tunnel junction (MTJ) stack comprising:
a first antiferromagnetic (AFM1) layer;
a ferromagnetic pinned layer adjacent to said AFM1 layer;
a ferromagnetic free layer; and
a tunnel barrier layer disposed between said pinned layer and said free layer;
a bias stack for applying a longitudinal bias field to said free layer, said bias stack comprising:
a second antiferromagnetic (AFM2) layer;
a first ferromagnetic (FM1) layer;
a second ferromagnetic (FM2) layer adjacent to said AFM2 layer;
an antiparallel coupling layer disposed between said FM1 and FM2 layers; and
a nonmagnetic spacer layer disposed between said FM1 layer and said free layer.

8. The magnetic tunnel junction (MTJ) magnetoresistive sensor recited in claim 7, wherein said FM2 layer has a thickness greater than the thickness of said FM1 layer and said FM1 layer has a positive (parallel) ferromagnetic coupling with said free layer.

9. The magnetic tunnel junction (MTJ) magnetoresistive sensor recited in claim 7, wherein said FM1 layer has a thickness greater than the thickness of said FM2 layer and said FM1 layer has a negative (antiparallel) ferromagnetic coupling with said free layer.

10. The magnetic tunnel junction (MTJ) magnetoresistive sensor recited in claim 7, wherein said spacer layer of the bias stack is selected from the group of materials consisting of copper (Cu), ruthenium (Ru), rhodium (Rh) and tantalum (Ta).

11. The magnetic tunnel junction (MTJ) magnetoresistive sensor recited in claim 7, wherein said spacer layer of the bias stack has a thickness in the range of 5-30 Å.

12. The magnetic tunnel junction (MTJ) magnetoresistive sensor recited in claim 7, wherein said FM1 and FM2 layers of the bias stack are selected from the group of materials consisting of Co—Fe, Co, Ni—Fe and Co—Fe—Ni.

13. A magnetic read/write head, comprising:
a write head including:
at least one coil layer and an insulation stack, the coil layer being embedded in the insulation stack;
first and second pole piece layers connected at a back gap and having pole tips with edges forming a portion of an air bearing surface (ABS);
the insulation stack being sandwiched between the first and second pole piece layers; and
a write gap layer sandwiched between the pole tips of the first and second pole piece layers and forming a portion of the ABS;
a read head including:
a spin valve (SV) sensor, the SV sensor being sandwiched between first and second shield layers, the SV sensor comprising:
a spin valve (SV) stack comprising:
a first antiferromagnetic (AFM1) layer;
a ferromagnetic pinned layer adjacent to said AFM1 layer;
a ferromagnetic free layer; and
a spacer layer disposed between said pinned layer and said free layer;
a bias stack for applying a longitudinal bias field to said free layer, said bias stack comprising:
a second antiferromagnetic (AFM2) layer;
a first ferromagnetic (FM1) layer;
a second ferromagnetic (FM2) layer adjacent to said AFM2 layer;
an antiparallel coupling layer disposed between said FM1 and FM2 layers; and
a nonmagnetic spacer layer disposed between said FM1 layer and said free layer; and
an insulation layer disposed between the second shield layer of the read head and the first pole piece layer of the write head.

14. The magnetic read/write head recited in claim 13, wherein said FM2 layer has a thickness greater than the thickness of said FM1 layer and said FM1 layer has a positive (parallel) ferromagnetic coupling with said free layer.

15. The magnetic read/write head recited in claim 13, wherein said FM1 layer has a thickness greater than the thickness of said FM2 layer and said FM1 layer has a negative (antiparallel) ferromagnetic coupling with said free layer.

16. The magnetic read/write head recited in claim 13 wherein said spacer layer of the bias stack is selected from the group of materials consisting of copper (Cu), ruthenium (Ru), rhodium (Rh) and tantalum (Ta).

17. The magnetic read/write head recited in claim 13, wherein said spacer layer of the bias stack has a thickness in the range of 5-30 Å.

18. The magnetic read/write head recited in claim 13, wherein said FM1 and FM2 layers of the bias stack are selected from the group of materials consisting of Co—Fe, Co, Ni—Fe and Co—Fe—Ni.

19. A magnetic read/write head, comprising:
a write head including:
at least one coil layer and an insulation stack, the coil layer being embedded in the insulation stack;
first and second pole piece layers connected at a back gap and having pole tips with edges forming a portion of an air bearing surface (ABS);
the insulation stack being sandwiched between the first and second pole piece layers; and
a write gap layer sandwiched between the pole tips of the first and second pole piece layers and forming a portion of the ABS;
a read head including:
a magnetic tunnel junction (MTJ) sensor, the MTJ sensor being sandwiched between first and second shield layers, the MTJ sensor comprising:
a magnetic tunnel junction (MTJ) stack comprising:
a first antiferromagnetic (AFM1) layer;
a ferromagnetic pinned layer adjacent to said AFM1 layer;
a ferromagnetic free layer; and
a tunnel barrier layer disposed between said pinned layer and said free layer;
a bias stack for applying a longitudinal bias field to said free layer, said bias stack comprising:
a second antiferromagnetic (AFM2) layer;
a first ferromagnetic (FM1) layer;
a second ferromagnetic (FM2) layer adjacent to said AFM2 layer;
an antiparallel coupling layer disposed between said FM1 and FM2 layers; and
a nonmagnetic spacer layer disposed between said FM1 layer and said free layer; and
an insulation layer disposed between the second shield layer of the read head and the first pole piece layer of the write head.

20. The magnetic read/write head recited in claim 19, wherein said FM2 layer has a thickness greater than the thickness of said FM1 layer and said FM1 layer has a positive (parallel) ferromagnetic coupling with said free layer.

21. The magnetic read/write head recited in claim 19, wherein said FM1 layer has a thickness greater than the thickness of said FM2 layer and said FM1 layer has a negative (antiparallel) ferromagnetic coupling with said free layer.

22. The magnetic read/write head recited in claim 19, wherein said spacer layer of the bias stack is selected from the group of materials consisting of copper (Cu), ruthenium (Ru), rhodium (Rh) and tantalum (Ta).

23. The magnetic read/write head recited in claim 19, wherein said spacer layer of the bias stack has a thickness in the range of 5-30 Å.

24. The magnetic read/write head recited in claim 19, wherein said FM1 and FM2 layers of the bias stack are selected from the group of materials consisting of Co—Fe, Co, Ni—Fe and Co—Fe—Ni.

25. A disk drive system comprising:
a magnetic recording disk;
a magnetic read/write head for magnetically recording data on the magnetic recording disk and for sensing magnetically recorded data on the magnetic recording disk, said magnetic read/write head comprising:
a write head including:
at least one coil layer and an insulation stack, the coil layer being embedded in the insulation stack;
first and second pole piece layers connected at a back gap and having pole tips with edges forming a portion of an air bearing surface (ABS);
the insulation stack being sandwiched between the first and second pole piece layers; and
a write gap layer sandwiched between the pole tips of the first and second pole piece layers and forming a portion of the ABS;
a read head including:
a spin valve (SV) sensor, the SV sensor being sandwiched between first and second shield layers, the SV sensor comprising:
a spin valve (SV) stack comprising:
a first antiferromagnetic (AFM1) layer;
a ferromagnetic pinned layer adjacent to said AFM1 layer;
a ferromagnetic free layer; and
a spacer layer disposed between said pinned layer and said free layer;
a bias stack for applying a longitudinal bias field to said free layer, said bias stack comprising:
a second antiferromagnetic (AFM2) layer;
a first ferromagnetic (FM1) layer;
a second ferromagnetic (FM2) layer adjacent to said AFM2 layer;
an antiparallel coupling layer disposed between said FM1 and FM2 layers; and
a nonmagnetic spacer layer disposed between said FM1 layer and said free layer; and
an insulation layer disposed between the second shield layer of the read head and the first pole piece layer of the write head;
an actuator for moving said magnetic read/write head across the magnetic disk so that the read/write head may access different regions of the magnetic recording disk; and
a recording channel coupled electrically to the write head for magnetically recording data on the magnetic recording disk and to the MTJ sensor of the read head for detecting changes in resistance of the MTJ sensor in response to magnetic fields from the magnetically recorded data.

26. The disk drive system recited in claim 25, wherein said FM2 layer has a thickness greater than the thickness of said FM1 layer and said FM1 layer has a positive (parallel) ferromagnetic coupling with said free layer.

27. The disk drive system recited in claim 25, wherein said FM1 layer has a thickness greater than the thickness of said FM2 layer and said FM1 layer has a negative (antiparallel) ferromagnetic coupling with said free layer.

28. The disk drive system recited in claim 25, wherein said spacer layer of the bias stack is selected from the group of materials consisting of copper (Cu), ruthenium (Ru), rhodium (Rh) and tantalum (Ta).

29. The disk drive system recited in claim 25, wherein said spacer layer of the bias stack has a thickness in the range of 5-30 Å.

30. The disk drive system recited in claim 25, wherein said FM1 and FM2 layers of the bias stack are selected from the group of materials consisting of Co—Fe, Co, Ni—Fe and Co—Fe—Ni.

31. A disk drive system comprising:
a magnetic recording disk;
a magnetic read/write head for magnetically recording data on the magnetic recording disk and for sensing magnetically recorded data on the magnetic recording disk, said magnetic read/write head comprising:
a write head including:
at least one coil layer and an insulation stack, the coil layer being embedded in the insulation stack;
first and second pole piece layers connected at a back gap and having pole tips with edges forming a portion of an air bearing surface (ABS);
the insulation stack being sandwiched between the first and second pole piece layers; and
a write gap layer sandwiched between the pole tips of the first and second pole piece layers and forming a portion of the ABS;
a read head including:
a magnetic tunnel junction (MTJ) sensor, the MTJ sensor being sandwiched between first and second shield layers, the MTJ sensor comprising:
a magnetic tunnel junction (MTJ) stack comprising:
a first antiferromagnetic (AFM1) layer;
a ferromagnetic pinned layer adjacent to said AFM1 layer;
a ferromagnetic free layer; and
a tunnel barrier layer disposed between said pinned layer and said free layer;
a bias stack for applying a longitudinal bias field to said free layer, said bias stack comprising:
a second antiferromagnetic (AFM2) layer;
a first ferromagnetic (FM1) layer;
a second ferromagnetic (FM2) layer adjacent to said AFM2 layer;
an antiparallel coupling layer disposed between said FM1 and FM2 layers; and
a nonmagnetic spacer layer disposed between said FM1 layer and said free layer; and
an insulation layer disposed between the second shield layer of the read head and the first pole piece layer of the write head;
an actuator for moving said magnetic read/write head across the magnetic disk so that the read/write head may access different regions of the magnetic recording disk; and
a recording channel coupled electrically to the write head for magnetically recording data on the magnetic recording disk and to the MTJ sensor of the read head for detecting changes in resistance of the MTJ sensor in response to magnetic fields from the magnetically recorded data.

32. The disk drive system recited in claim 31, wherein said FM2 layer has a thickness greater than the thickness of said FM1 layer and said FM1 layer has a positive (parallel) ferromagnetic coupling with said free layer.

33. The disk drive system recited in claim 31, wherein said FM1 layer has a thickness greater than the thickness of said FM2 layer and said FM1 layer has a negative (antiparallel) ferromagnetic coupling with said free layer.

34. The disk drive system recited in claim 31, wherein said spacer layer of the bias stack is selected from the group of materials consisting of copper (Cu), ruthenium (Ru), rhodium (Rh) and tantalum (Ta).

35. The disk drive system recited in claim 31, wherein said spacer layer of the bias stack has a thickness in the range of 5-30 Å.

36. The disk drive system recited in claim 31, wherein said FM1 and FM2 layers of the bias stack are selected from the group of materials consisting of Co—Fe, Co, Ni—Fe and Co—Fe—Ni.
